(19) United States
(12) Patent Application Publication
(10) Pub. No.: US 2026/0144263 A1
(43) Pub. Date: May 28, 2026

(54) PROCESS FOR PREPARATION OF A BIOFORMULATION AND ITS APPLICATION THEREOF

(71) Applicants: Ajitkumar Shridhar PARAB, SINDHUDURG, MAHARASHTRA (IN); Babita Rajesh BHATKANDE, KARNATAKA, BELGAUM (IN)

(72) Inventor: Ajitkumar Shridhar PARAB, SINDHUDURG, MAHARASHTRA (IN)

(73) Assignees: Ajitkumar Shridhar PARAB, SINDHUDURG, MAHARASHTRA (IN); Babita Rajesh BHATKANDE, KARNATAKA, BELGAUM (IN)

(21) Appl. No.: 19/123,438

(22) PCT Filed: Oct. 26, 2023
(86) PCT No.: PCT/IN2023/050984

§ 371 Date: Apr. 23, 2025

(30) Foreign Application Priority Data
Oct. 26, 2022 (IN) 202221048721

(51) Int. Cl. A01N 65/44; A01N 25/02; A01P 7/04; B09B 3/70; C02F 1/50; C02F 103/00; C02F 103/06; C05G 5/23

(52) U.S. Cl. CPC A01N 65/44; A01N 25/02; A01P 7/04; B09B 3/70; C02F 1/50; C05G 5/23; C02F 2103/007; C02F 2103/06

(57) ABSTRACT

A process of preparing a bioformulation includes the stages of preparing air conditions having least contamination for the making of the bioformulation; preparing the bioformulation in the enclosure while maintaining air conditions having least contamination; and initiating enrichment of the bioformulation using cloths. Further is described a method of preparing working solutions from the stock solution of the bioformulation. The working solution of bioformulation is used for treating waste water, polluted soil, polluted air, solid wastes, etc. The process is sustainable and ecofriendly. The process utilizes raw materials that are easily available. The bioformulation of the present invention is useful for bioremediation.

### FIELD OF THE INVENTION

The present invention relates to a process for preparing a bioformulation and particularly relates to a process for preparing a bioformulation capable of altogether in situ bioremediation.

### BACKGROUND OF THE INVENTION

Human activities, often referred to as anthropogenic activities, play a significant role in the contamination of essential environmental elements, namely soil, air, and water. These activities encompass a wide range of practices, including the combustion of fossil fuels, industrial processes, the widespread use of chemical fertilizers and pesticides in agriculture, improper waste disposal, rapid urbanization, deforestation, mining operations, construction projects, wastewater discharge, power generation, and the production of plastics. These practices collectively contribute to the degradation of the quality of soil, air, and water resources.

Air pollution and the ever-increasing specter of climate change are driven by the release of greenhouse gases and other noxious pollutants into the atmosphere. These pollutants are emitted by a multitude of industrial processes. They include a daunting array of compounds, such as carbon dioxide, sulfur dioxide, nitrogen oxides, methane, particulate matter, and chlorofluorocarbons (CFCs). The adverse effects of these emissions extend far beyond mere air quality, with far-reaching implications for global climate patterns.

In addition to atmospheric contamination, industrial discharges contribute to the deterioration of water quality and the phenomenon of eutrophication. These discharges involve a broad spectrum of pollutants, including heavy metals, organic and chemical compounds, pesticides, herbicides, chemical fertilizers, runoff from agricultural practices, excessive nutrient loads, runoff from construction sites, sewage effluents, and the devastating consequences of oil spills. These pollutants wreak havoc on aquatic ecosystems, posing threats to both the environment and human health.

Moreover, agricultural practices further compound the issue. The excessive use of chemical fertilizers and pesticides in farming contributes to soil degradation. These practices release heavy metals, minerals, and harmful chemicals into the soil, rendering it increasingly barren and unsuitable for agriculture. The expanding footprint of urbanization further exacerbates soil pollution and erosion, making it a pressing concern for sustaining agricultural productivity.

The adverse impact of these pollutants on both the environment and human health is undeniable. As a result, it is imperative to adopt comprehensive strategies aimed at both preventing and mitigating pollution. Over time, various methods have been employed to address pollution issues, with the objective of safeguarding our environment and public health. These methods encompass a diverse range of approaches, including the establishment of stringent environmental regulations. By setting specific standards and guidelines, these regulations aim to control emissions and waste disposal practices. Concurrently, improvements in waste management and wastewater treatment procedures have been implemented, leading to more responsible handling of pollutants and contaminants.

Additionally, the adoption of sustainable practices and cleaner technologies has gained traction as a means to reduce the environmental footprint of various industries. This shift towards sustainability reflects a growing recognition of the importance of preserving natural resources and minimizing pollution. Such efforts represent significant steps toward pollution prevention and mitigation.

In the domain of wastewater management, large-scale sewage and wastewater treatment facilities have been established to treat contaminated water. These facilities have played a pivotal role in improving the quality of water resources. Nevertheless, it's essential to acknowledge that these wastewater treatment processes come with substantial capital and operational costs. They are often energy-intensive procedures, necessitating a thoughtful balance between environmental benefits and economic considerations.

Moreover, the prior art has explored the implementation of various biological approaches to address pollution issues. Phytoremediation and bioremediation stand out as notable methods within this realm. These biological techniques hold the promise of reducing or eliminating hazardous pollutants from contaminated soil, water, and air, presenting a sustainable and eco-friendly path forward in pollution management.

In the area of pollution remediation, innovative methods have emerged to tackle the challenges posed by contaminants in soil, water, and other environmental matrices. Notably, the Canadian Patent Application CA2868203A1 to Pisanova Elena and Rovison John introduces an environmental remediation method that focuses on the oxidation of organic compounds found in soil, groundwater, process water, and wastewater. This method utilizes persulfate and ferrous lactate to initiate the oxidation process, offering a potential solution to address pollution concerns.

It is important, however, to exercise caution when deploying chemical-based remediation methods. While such methods hold promise in treating contaminants, the excessive use of chemicals may inadvertently impact the quality of soil or water resources, introducing unintended consequences that necessitate a balanced approach in pollution management.

Notably, the PCT Application WO2023123426A1 to by Liu Peng et al. discloses a novel soil remediation system and method. This method involves the heating of contaminated soil, pumping underground water, and the injection of a remediation agent. Nevertheless, it's imperative to acknowledge that the application of such methods on extensive contaminated sites can be burdensome, expensive, and labor-intensive, underscoring the need to strike a balance between the efficacy of pollution control and practical considerations.

Specifically, the PCT Application WO2020261287A1 to Srinivasan and N. A. Mahalakshmi teaches a pioneering bioremediation approach for addressing crude oil spills across diverse environmental contexts, including sea, soil, surfaces, lands, water, rhizospheres, and ecosystems, with a focus on utilizing bacteria. Nevertheless, it's crucial to acknowledge that microbe-based remediation, especially when deployed in-situ, is not without its limitations. One notable concern is the potential for the bacteria themselves and/or the enzymes they produce to disperse too rapidly from the contamination site or to encounter difficulties in efficient delivery, underscoring the need for a balanced approach in pollution management.

An alternative and eco-friendly approach to reduce or eliminate pollutants from both soil and water resources involves the use of phytoremediation. This technique leverages the natural ability of plants to absorb, metabolize, and store contaminants, ultimately cleansing the environment. However, the efficacy of phytoremediation is contingent upon a critical step in the process of the selection of appropriate plant species.

There is a need for a sustainable and environment friendly process and a bioformulation for the treatment of polluted environment. There is also a need of bioformulation that effectively converts harmful and toxic substances into beneficial products and achieves altogether speedy in situ treatment of soil, water and air in the environment.

### SUMMARY OF THE INVENTION

The present invention relates to a process of preparing a bioformulation includes a first stage of preparing air conditions having least contamination for the making of the bioformulation; a second stage of preparing the bioformulation in the enclosure while maintaining air conditions having least contamination; and a third stage of initiating enrichment of the bioformulation using cloths.

The first stage of preparing air conditions having least contamination for the making of the bioformulation further includes a first step of cleaning the hands by the personnel; a second step of preparing the site in vicinity of selected trees; and a third step of preparing the enclosure wherein the bioformulation being prepared. The first step of cleaning the hands by the personnel including the person being involved in the preparation of the bioformulation to clean their hands up to the elbow by washing twice with ash and clean water followed by air drying the hands.

The second step of preparing the site in vicinity of selected trees including selecting the trees from cluster fig and banyan; removing the unwanted plants and seedlings; allowing leaves, fruits and branches falling from the two selected trees to fall on the ground and remaining there till decay; regularly keeping the soil below the trees wet with water; spreading 40 kg fine powdered quartz (passed through <300 micron mesh) mixed with 8 kg organic turmeric powder in a 10 feet diameter around the cluster fig tree, and spreading 100 kg fine powdered quartz (passed through <300 micron mesh) without any turmeric powder in a 30 feet diameter around the banyan tree; and placing under these trees, on the quartz powder, in two layers, naturally smoothened stones, brought from polluted areas, such that the polluted areas being selected from polluted ecosystems or area, fields, farms, gardens where insecticides and pesticides being used, polluted water streams, rivers, sources, urban and human affected places, pens for birds and animals.
The third step of preparing the enclosure for preparation of bioformulation including constructing the enclosure in the vicinity of the selected trees such that the enclosed built environment being conducive for easy air ventilation; the enclosure being at 900 of both the trees and 40 feet away from the cluster fig tree in south direction and 40-50 feet away from the Banyan Tree in East direction; the enclosure measuring 65 feet in North South direction and 45 feet in East West direction.

The second stage of preparing the bioformulation in the enclosure while maintaining air conditions having least contamination including a first step of placing an open plastic barrel of 200 litre capacity on two Black Limestones called ‘P platform’ and adding 180 litre water to the barrel followed by addition of jaggery, such that the proportion of jaggery being 1 kg per 100 Litre of water, and keeping the mixture undisturbed without stirring on the day 1 after adding jaggery; a second step of adding more jaggery on Day 2 followed by introducing a wooden plank obtained from jackfruit tree being allowed to remain there in the barrel such that the size of the wooden plank being smoothened with a carpenter plane to 4 inch wide one inch thick and 5 feet long, and few scratches being made with iron nail on all four sides of the smoothened plank, and the plank being changed every month, and the old plank being left under the banyan or Cluster fig tree touching its trunk; a third step of aerating the mixture in the barrel by an external air pump ensuring proper air-circulation in the mixture for preparing the bioformulation, such that a stone procured from natural habitat having no human interference being tied to the pipe end with cotton thread and the pipe being lowered inside, the pipe so dipped being changed every month and the old one being left under the Cluster fig or Banyan tree touching its trunk; and a fourth step of covering the container for making the bioformulation with double layered cloth such that the cloth piece being 4 feet×8 feet size, the cloth being immersed for 8 hours in water in a glass vessel being kept near the 2 feet×3 feet Black Limestone outside the circumference of quartz soil at Banyan tree, the cloth being taken out and dried on the plastic string in shaded area without squeezing or wringing, removing the cloth with clean hands and keeping on the said Black Limestone and spreading 50 gm ash on it, keeping the ash on the cloth for 2 hrs., picking the cloth along with the ash and keeping in another glass vessel without meddling with it, pouring cold water on cloth to such an extent that a cloth being sufficiently drenched but only partially immersed in the water in the glass vessel, keeping for 4 hrs, shaking the cloth after stipulated 4 hrs only once in the pot itself and pouring 1 litre water on the cloth holding it above the glass vessel, taking the cloth immediately for spreading on another string without squeezing or wrinkling in the shaded area, pouring remaining water in the vessel 36 hrs. after removal of cloth under the Banyan tree inside the circumference of quartz soil at Banyan tree, double layering the cloth and putting on the barrel wherein the bioformulation being developed, the barrel being covered with cloth in a such a way that the portion of the wood plank obtained from jackfruit tree remains out of the barrel not getting covered by the cloth, tying by the coir rope after covering the barrel with double layered cloth, and arranging a plastic string for keeping the cloth as and when it being removed from the barrel.

The third stage of initiating enrichment of the bioformulation using cloths including a first step of preparing the cloth at the enclosure; a second step of preparing the cloth at the polluted site; a third step of treating the cloth at the polluted site; a fourth step of treating the cloths at the enclosure; a fifth step of contacting the cloths with banyan tree; a sixth step of contacting the cloths with the bioformulation; and a seventh step of taking the cloths to the polluted site.

The process further includes preparing a working solution from the bioformulation by sequential addition of jaggery to 10 ml of stock solution to prepare 100 litres of working solution. The working solution of the bioformulation is used for wastewater treatment, solid waste treatment, treating polluted soil, to enhance plant growth and seed treatment, vegetative propagation, treating polluted air, treating polluted rivers, streams, ponds, lakes and wells wherein water is in contact with soil and mosquito control wherein the mosquitoes are in adult or larvae form.

### BRIEF DESCRIPTION OF DRAWINGS

FIGS. 1a and 1b depicts the results of ambient air analysis after the application of the bioformulation of the present invention; and

FIG. 2 depicts the results of water analysis after the application of the bioformulation of the present invention;

### DESCRIPTION OF THE INVENTION

References in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

References in the specification to “preferred embodiment” means that a particular feature, structure, characteristic, or function described in detail thereby omitting known constructions and functions for clear description of the present invention.

The foregoing description of specific embodiments of the present invention has been presented for purposes of illustration and description. They are not intended to be exhaustive or to limit the present invention to the precise forms disclosed and obviously many modifications and variations are possible in light of the above teaching.

In one aspect, the present invention describes a process of preparation of a bioformulation. The said bioformulation is used for in-situ purification of the soil, water, and air by neutralizing the toxic effect of the pollutants or contaminants in the form of toxic, hazardous, harmful organic and inorganic matter.

In accordance with the present invention, the preparation of the bioformulation includes various stages as follows:
Stage 1: Preparing air conditions having least contamination for the making of the bioformulation that includes the steps of: i) Cleaning of hands by the personnel; ii) Preparation of the site in vicinity of selected trees and iii) Preparation of the enclosure wherein the bioformulation is prepared.
Stage 2: Preparing the bioformulation in the enclosure while maintaining air conditions having least contamination; and
Stage 3: Initiating enrichment of the bioformulation using cloths that includes the steps of: i) preparing the cloth at the enclosure; ii) preparing the cloth at the polluted site iii) treating the cloth at the polluted site; iv) treating the cloths at the enclosure v) contacting the cloths with banyan tree; vi) contacting the cloths with the bioformulation and vii) taking the cloths to the polluted site.

In this embodiment, the stage 1 of preparing air conditions having least contamination for the making of the bioformulation includes the steps of:

Step 1: Cleaning of hands by the personnel wherein the person involved in the preparation of the bioformulation cleans their hands up to the elbow by washing twice with ash and clean water followed by air drying the hands.

Step 2: Preparation of the site in vicinity of selected trees wherein the selected trees are cluster fig and banyan tree. The unwanted plants and seedlings are removed. Leaves, fruits and branches falling from the two selected trees were allowed to fall on the ground and remain there till decay. The soil below the trees was regularly kept wet with water.

In a 10 feet diameter around the cluster fig tree, 40 kg fine powdered quartz (passed through <300 micron mesh) mixed with 8 kg organic turmeric powder was spread. Further, in a 30 feet diameter around the banyan tree, 100 kg fine powdered quartz (passed through <300 micron mesh) without any turmeric powder was spread.

Under these trees, on the quartz powder, in two layers, naturally smoothened stones, brought from polluted areas were placed. The polluted areas are selected from Polluted ecosystems or area, Fields, farms, gardens where insecticides and pesticides are used, Polluted water streams, rivers, sources, Urban and human affected places, Pens for birds and animals etc.

Step 3: Preparation of the enclosure wherein the bioformulation is prepared. The enclosure is constructed in the vicinity of the selected trees mentioned in Step 2. This enclosed built environment is conducive for easy air ventilation. The enclosure is at 900 of both the trees and 40 feet away from the cluster fig tree in south direction and 40-50 feet away from the Banyan Tree in East direction. The enclosure measures 65 feet in North South direction and 45 feet in East West direction and is constructed in the manner as follows.

The enclosure area is cleared by removing all the remains of leaves, fruits, flowers, and other parts of vegetation. Plastic, glass, metal parts/particles were also removed.

The enclosure has laterite stone walls on all four sides. A base is made on all four sides to support the wall. Cross sectional sizes of the base are 30 inches in width and 30 inches in height. This base is built using naturally occurring stones from various riverbeds and mud mortar. Mud mortar was prepared by adding fresh cow dung in locally available soil. Once the base is done, 15-inch-thick laterite wall on all four sides were made using lime mortar. Door and windows were provided as described further. To support the roof structure, unpainted steel stanchions were erected at 2 feet inside the wall. Holes were made in the ground and stanchions were erected using stones and soil only. These steel column sections were used as props for supporting the roof. Iron instruments like pickaxe, shovel were used during erection of the wall and 6 feet high walls were constructed. On this 30 inch wide base, 6 feet high wall having 15 inch width was constructed from laterite stone with the help of lime mortar. Lime-sand ratio was kept as required.

A 36 inch wide door is provided on the west side wall of the building and open windows with wooden frames were made on all 4 sides at 2 feet height above the 30 inch wide base. A fine aluminium mesh is fixed on the wooden windows after all the construction is done. Wood from various indigenous local trees was used for making the windows.

The clear inside height of all windows is 3 feet and sum of the internal lengths on each side of the wall are as follows.

| Side (Direction) | Length of window |
|---|---|
| East | 08 feet |
| West | 28 feet |
| North | 16 feet |
| South | 08 feet |

All the walls were kept unplastered from inside and outside plastering was done with sand and clay mixture. Only plastic tools (and no metal tools) were used for making and using this sand clay mortar for plaster work. Even the handles for shovels were also made from plastic. The mortar was splashed on the wall with the help of hands and the levelling plank used for plastering was made from Jack fruit tree wood in which copper screws were used.

G. I. sections were used for making the roof. The prefabricated parts were assembled in the enclosure premises without entailing any welding work. The roof structure was prepared by assembly of prefabricated sections and by fixing insulated colour coated sheets. The roof overhang was kept to provide shade on the windows. Ceiling was done using plain asbestos sheets by keeping some distance from the roof.

Proper care was taken to keep away the entry of animals, birds, bats, rats and insects and then made the following preparations. After cleaning the inside area, a 2 feet high sand bed was prepared. Fine sand (300 micron) without any trace of salt content was sieved using stainless steel sieve mesh. The sand so sieved and washed was used for making the bed. The sand bed was watered till saturation using well water for first 15 days and further watered daily to maintain the moisture content.

Black Limestones of thickness 35-45 mm and 2×4 feet size each are laid on the sand bed These two Black Limestones are touching each other at the centre of the enclosure on the sand-bed with their smooth side upward. These two Black Limestones are named as P1 & P2 and the Base of the platform so created by two tiles measuring 4×4 feet size was named as ‘P platform’.

3 feet space was kept vacant on all 4 sides of the ‘P platform’ and 22 Nos. of Black Limestones admeasuring 2×2 feet each were placed touching each other on four sides. 4 feet wide passage was kept for movement. All these one side polished Black Limestone Tiles were placed so that their rough sides faced upward.

Another Black Limestone was placed on each Black Limestone keeping its rough side down. In so doing, 22 Black Limestone sandwiches were formed their rough sides touching each other and they were named as Ks1, Ks2 . . . Ks22. The structure formed by the 22 sandwiches was named as ‘22 sandwich square’. 7 Black Limestones were placed on each North and South side of the ‘22 sandwich square’ in the following manner. On the north side 3 platforms named as A North, B North and C North are placed. On the south side 3 platforms named A South, B South & C South are placed.

### For the Formation of ‘a North Black Limestone Platform’—

A distance of 5 feet is kept on north side from ‘22 sandwich square’-two one side polished Black Limestones of 2×3 feet size each were placed touching each other. Their rough sides were kept upward. These two Black Limestones named as ‘A North a’ and ‘A North b’ being kept adjacent to each other, a platform was created 6 feet long on East West direction and 2 feet wide on North South direction. These Black Limestones are placed in such a way that they slope slightly towards the ‘22 Sandwich square’.

A South platform was made in the same manner by using ‘A South a’ and ‘A South b’ Black Limestone on the South side of the 22 Sandwich square. Then ‘B North’ and ‘B South’ Black Limestone platforms were made on the north and south sides of the ‘A North’ and ‘A south’ platforms respectively.

To form ‘B north platform’, three Black Limestones admeasuring 2×2 feet were kept touching each other and keeping their polished sides upwards. These three Black Limestones named as ‘B North a’, ‘B North b’ and ‘B North c’ when kept together formed a 6 feet long rectangular platform in east west direction. This ‘B North platform’ was kept at the water level. ‘B South platform’ was formed on the south side of the ‘A South platform’ adjacent to it.

Then ‘C North’ and ‘C South’ platforms were formed in the following manner.

2 Black Limestones of 3 feet×3 feet size each were kept touching each other on the North side of the B North Black Limestone platform touching its 6 feet long side. Rough sides of all these one side polished Black Limestones was kept facing upwards. Since both Black Limestones named as ‘C North a’, and ‘C North b’ were kept touching each other sideways, a 6 feet Long platform in east west direction was formed. This ‘C North platform’ has a one inch slope in the direction of ‘B North platform’. In the same manner ‘C South platform’ was constructed on the South side of the ‘B South platform’.

As a result of this, a big ‘ABC North platform’ was created on the North side of the ‘22 sandwich square’ by joining 3 platforms of A North, B North and C North platforms making it's size as 7 feet North South and 6 feet East West. The similar ‘ABC South platform’ was formed on the South side of the ‘22 sandwich square’.

Further, four nos. of coir strings were tied in the east west direction at a distance of 7 inch from each other over the C North and C South platforms at the height of 6 feet from the ground level.

Another Black Limestone set was formed by taking 4 nos. 1 feet×1 feet size Black Limestone naming them as R1, R2, R3 and R4 at a distance of 4 feet on the west side of ‘22 Sandwich square’. The rough sides were kept upwards of all these one side polished Black Limestones and they were kept touching each other in such a way that slope of all the 4 Black Limestones was towards the centre of all. Due to such formation a set of 2×2 feet was formed from 4 Black Limestones and it was named as ‘R set’.

In this embodiment, the stage 2 of preparing the bioformulation in the enclosure includes the steps of:

Step 1: Placing an open plastic barrel of 200 Litre. Capacity on two Black Limestones called ‘P platform’ and adding 180 litre Water to the barrel followed by addition of jaggery. In this step, the proportion of jaggery was 1 kg. per 100 Litre. of water. Accordingly total 1.8 kg. Jaggery was mixed in it. After adding jaggery on the first day, the mixture was not stirred and kept undisturbed.

Step 2: Adding more jaggery on Day 2 followed by introducing a wooden plank obtained from jackfruit tree that is allowed to remain there in the barrel. In this step, the size of the wooden plank which was smoothened with a carpenter plane was 4 inch wide one inch thick and 5 feet long. Few scratches were made with iron nail on all four sides of the smoothened plank. This plank was changed every month and the old plank was left under the banyan or Cluster fig tree touching its trunk.

Step 3: Aerating the mixture in the barrel by an external air pump that ensures proper air-circulation in the mixture for preparing the bioformulation. This external air pump had a capacity of 25 liter air blow Per minute. A stone procured from natural habitat having no human interference was tied to the pipe end with cotton thread and the pipe was lowered inside. The pipe so dipped was changed every month and the old one was left under the Cluster fig or Banyan tree touching its trunk.

In this stage 2, jaggery is added thrice as mentioned below.

| | |
|---|---|
| First day | 25% (450 gm) |
| Second day | 25% (450 gm) |
| Third day | 50% (900 gm) |

From the second day onwards, the mixture was stirred with the wooden plank twice in a day up till 5th day. No jaggery was added additionally on 4th and 5th day.

Further, 25% liquid i.e. 45 Litre quantity was taken out for use from 5th day onwards on every alternate day. A plastic bucket and plastic mug was used for this purpose. The mug was kept in the bucket itself with a view to avoid contact to the soil. The mixture was stirred everyday once at 8 am (morning), the culture was taken out at 5 pm (evening). Jaggery and water were added at the same time and the solution was stirred once again at 9 pm (night).

Out of these 45 litres, half litre liquid was poured on the joint where P1 & P2 Black Limestone touch each other. The remaining liquid was poured on following three spots on the specified days at evening time.
1. On every 12th day—on aerial roots of the ‘Reviver Banyan’ tree within the circumference of ‘quartz soil’.
2. On every 5th day after pouring on the aerial roots of the Banyan tree-any spot at the ‘quartz soil at cluster fig’ tree.
3. On all other days—the liquid taken out was poured at the base of Banyan Tree in the polluted ecosystem. And this chain of pouring the liquid at all three places was continued.

Every time a 45 litre jaggery mixed liquid was taken out from the barrel, water and jaggery was added afresh into it so as to maintain the volume of the solution at 180 litre level.

Step 4: Covering the container used for making the bioformulation with double layered cloth wherein a cloth piece of 4 feet×8 feet size is required for this step.

This cloth cut out of fresh cloth length, was immersed for 8 hours in water in a glass vessel kept near the 2 feet×3 feet Black Limestone outside the circumference of quartz soil at Banyan tree. The cloth was taken out and dried on the plastic string in shaded area without squeezing or wringing. With clean hands the dried cloth was removed and kept on the said Black Limestone and 50 gm ash was spread on it.

After keeping the ash on the cloth for 2 hrs. the cloth was picked up along with the ash and kept in another glass vessel without meddling with it or touching the cloth. Cold water was poured on cloth and water was poured to such an extent that a cloth was sufficiently drenched but only partially immersed in the water in the glass vessel. This was kept for 4 hrs.

After stipulated 4 hrs. this cloth was shaken only once in the pot itself and taken out. 1 litre water was poured on the cloth holding it above the glass vessel. Care was taken that while pouring the water on cloth 25 to 35% of the water falling on the cloth will spill outside of the vessel and will fall on the Black Limestone and 70-75% water will fall in the glass vessel itself. After pouring down the water the cloth was immediately taken up for spreading on another string without squeezing or wrinkling in the shaded area and was taken into use after it was dried well.

36 hrs. after removal of cloth from the glass vessel, remaining water in the vessel was poured under the Banyan tree inside the circumference of quartz soil at Banyan tree.

This cloth was double layered and was put on the barrel in which the bioformulation was getting developed. The barrel was covered with cloth in a such a way that the portion of the wood plank obtained from jackfruit tree that remains out of the barrel, will not get covered by the cloth.

After covering the barrel with double layered cloth, it was tied by the coir rope. A plastic string was arranged for keeping the cloth as and when it was removed from the barrel.

In this embodiment, the stage 3 of initiating enrichment of the bioformulation includes the steps of:

Step 1: Tying plastic strings 6 feet high from the ground level at any shaded place outside the ‘quartz soil at Banyan’ followed by immersing two cloths in 10 litre water in a glass vessel for 8 hours. After 8 hours, both cloths were taken out and without wrinkling, rinsing or squeezing kept for drying on the plastic string in shaded area.

A clean Black Limestone measuring 2 feet×3 feet was kept near them and both dried cloths were kept on it. 50 gm ash was spread on each cloth. After keeping it in the same position for 2 hours, the cloths were taken up along with ash on it and kept in other plastic vessel and 100 gm turmeric powder was spread on it.

Without touching or stirring again, water was poured on both these clothes. Water was poured in small quantity so that the clothes will get almost wet but they will only immerse half in the water. The cloths were kept in that state for 4 hours.

After stipulated 4 hours, both cloths were taken out of the plastic vessel one by one by shaking them only once inside the vessel and one litre water was poured on each cloth, while holding them over the container. It was seen that 25% to 30% of the water poured on the cloth will spill outside the glass vessel on the Black Limestone and 70% to 75% water will gather inside the vessel. After pouring the water, both the cloths were immediately kept on the plastic string for drying in shaded area (without squeezing them). The cloth pieces are now ready to be used for further steps.

Both the cloths were folded separately, and separate packets were made in blank papers. These two packets were again folded in separate blank papers and separately tied by cotton thread. Both the packets were stuffed in a plastic bag and the bag was sealed by adhesive tape. This sealed bag was again put in another plastic bag and it was tightly sealed by another adhesive tape.

Step 2: The prepared cloths of the previous step were taken to a polluted area wherein the cloths are 2×5 feet each and are kept in the plastic bag. The polluted area has high toxicity level but has the natural temperature of that surroundings. The polluted area is selected in a way that it is located in the vicinity of any of the existing indigenous tree selected from Ficus racemose (Cluster fig), Ficus benghalensis (Banyan), Ficus religiosa (Peepal), Azadiricta indica (neem), Butea monosperma (Palas) or Madhuca longifolia (Moha) variety wherein the trees are minimum 20 feet in height.

A specific site was further selected near the selected tree but out of its canopy circumference wherein the ground surface has natural soil. A small structure admeasuring 10×13 feet was made having non insulated roof and having opening of 3×3 feet for ventilation from any of the one side only. Further care was taken that no interference was made by animals, birds, rodents, bats or other troubling insects.

Alternatively, in case no tree is available of the above description in the polluted area or the tree is not high enough to match the requirement. Any of the above named trees were planted in the plastic pot measuring 15×15×12 inch and a few small apertures were made at the bottom to drain out the excess water. The pot is filled with fine sand or soil for planting the sapling. In case of having availability of very fine sand variety, about 10% soil from the polluting surroundings is mixed in it.

Two plastic pipes of 1-inch outer diameter were hung at a height of 5 feet keeping a distance of 3 feet between them. If the tree is planted in the pot, the pot was kept on the ground between both pipes. Using plastic/Rubber hand gloves on clean hands, both the cloths are taken out of the plastic bags and spread separately on the pipes, with precaution that no body part touches the cloth. The cloths are spread symmetrically and it is ensured that the ends of the cloth hang about 30 inches high from the ground.

Step 3: The jaggery mixed water was brought from the barrel on ‘P platform’ and was diluted by adding 3 times more pure water into it. This mixture was fed to the tree/trees by selecting a specific time i.e., eight hours before the time of highest pollution level in air. In case potted plant is used, 4 litre of the mixture was fed and in case the trees of the surroundings are used, 20 litre of the mixture was given to the tree standing in the soil.

In summer days and if the Tree on soil is being watered, giving water to the tree should be stopped 15 days before the mixture is given to the tree. If the soil in the polluted area remains moist or water logged or during rainy season an additional plant should be kept in the pot near the existing tree in the soil.

After 8 hours, i.e. at the time of highest level of pollution in the air, tree on the soil was watered. It was given water in full which means the water was given to such an extent that the soil was completely drenched and water was oozing out and for the plant in pot, water was given till saturation.

Then 250 ml. pure water was sprayed on both the cloths with hand spray. And spraying of water was done with the care that water will get absorbed by the cloth and it will not drip down.

Further the specific site having an area of 130 sq. feet is closed for a minimum period of 18 hours and human entry was prohibited except for authorized personnel. For the next 5 days, both the cloths were sprayed with 250 ml. pure water each by hand spray once in a day, when the pollution in the air was at the highest level. 24 hours after the 5th day, both the cloths were removed with clean hands. Both the cloths were folded separately. Separate packets were made in blank paper and tied by cotton thread. These two packets were again folded in separate blank papers and separately tied by cotton thread. Both the packets were stuffed in a plastic bag and the bag was sealed by adhesive tape. This sealed bag was again put in another plastic bag and it was tightly sealed by another adhesive tape. Both cloths were taken to the enclosure for further treatment. The plant with grown the pot was also brought to the designated place and kept in the periphery of quartz soil at Banyan Tree.

Step 4: The bag containing cloths brought from pollution affected area was taken inside the enclosure, where the bioformulation is developed. The cloths were removed from plastic bags and placed one by one on ‘A North a’ and ‘A South a’ platform, cold but fresh ash was put on both cloths in quantity of 30 g each. Two plastic containers, 30 inch in height were placed on ‘B North a’ and ‘B South a’ Black Limestone, After two hours, both the cloths along with the ash on them were gently lifted and kept in the containers near them one by one within 5 minutes.

30 g Turmeric powder was spread on each cloth with the help of plastic spoon. While spreading turmeric powder on the cloth in the container care was taken that no amount of it will spill outside the bucket. Next water was poured slowly on both the cloths on which the turmeric powder was spread. While performing this, care was taken that cloth is not touched by hand. While pouring the water, care was taken that the cloths will be half immersed in water and portion of the cloths will remain dry. The cloths were kept in this position for next four hours.

After 4 hours time, with clean hands, the cloth kept in the bucket on the ‘B North a’ Black Limestone was taken in right hand and immersed only once in the container and taken out. One litre water was poured on it with the help of left hand.

While pouring the 1 Liter Water, it was seen that 25%-30% of the water will fall outside the bucket on the ‘B North a’ Black Limestone and 70-75% quantity will fall in the bucket itself. After pouring the water, the cloth was immediately placed for drying without squeezing or wringing the cloth.

For drying purpose, the cloth was spread on any of the 4 lines of coir strings tied on the ‘C North’ Black Limestone platform. It was seen that both the ends of the cloth meet together, and they stick together. The water drippings from the cloth were allowed to fall on the ‘C North’ Black Limestone platform. Since both the Black Limestones in the C North platform had a moderate slope, the seeping water had flown down and ended in the sand bed. This process, in case of both the cloths, was completed within 15 minutes.

Both the containers containing water mixed with turmeric powder and ash are allowed to remain for next 96-100 hours on the respective Black Limestones. 12 hours after placing the cloth on coir strings for drying purpose, both the activities of watering the sand bed and sprinkling water on the Banyan Tree leaves cover were stopped.

After stipulated 96-100 hours The plastic container kept on ‘B North a’ Black Limestone was brought near R set. The liquid in the container was stirred only once by moving the container in clock-wise direction without putting hands in the solution. All liquid was poured slowly on ‘R Black Limestone set’. The liquid in the plastic container kept on ‘B South a’ Black Limestone was poured on ‘R Black Limestone’ set in the same manner and both containers were kept near R set on the sand bed. Afterwards, one litre water was poured in each container and both containers were stirred with the help of both hands in clock wise direction, only once as done earlier. The liquid was poured on R Black Limestone set. Since all the 4 Black Limestone had a slope towards its center, the liquid poured on the set percolated through its center and went to the sand underneath. Afterwards, both the plastic containers were moved to their original position and placed on ‘B North a’ and ‘B South a’ Black Limestone respectively.

Further steps were done by two persons jointly. These two persons are given the names as P1 & P2. The P2 Person cleaned his hands in the manner specified earlier and was ready to wash the A North Black Limestone whereas P1 person poured 12 litre water in the plastic container kept on B North a Black Limestone and washed the inside of the container with his hands in neat and orderly manner. Person P2 poured the washed water slowly on the ‘A North a’ Black Limestone. This is the same Black Limestone on which was kept the cloth and ash was splashed.

A small amount of ash had fallen on that Black Limestone. Due to the force of the water poured, the ash has flown down and went to be absorbed in the sand-bed. Once again, the 12 Litre Water was taken in the plastic container and cleaned vigorously with the help of both hands and poured the water slowly on the same Black Limestone. However, the P2 person washed the Black Limestone by rubbing and cleaning it properly. The P1 & P 2 persons did the same process in case of plastic container kept on B South a Black Limestone.

Both the P1 & P2 persons moved to the ‘B North a’ Black Limestone and P1 person picked up the plastic container on the Black Limestone and kept it on ‘B North b’ Black Limestone. He poured 5 Litre Water in the plastic container which was wet inside and added 50 gm Turmeric powder and stirred the content with the help of plastic pipe.

Later, P2 person cleaned both of his hands with ash and gently removed the cloth kept drying on the ‘C North’ platform with his wet hands. He immersed the cloth in the turmeric powder mixed water and allowed it to remain in the same position for next two hours.

Both the persons repeated this process for the plastic container on the ‘B South a’ Black Limestone. Also, the P2 person gently removed the cloth kept drying on the coir string over the ‘C South’ platform, and immersed the cloth in the turmeric powder mixed water. However, he had not washed his hands with ash this time. He used his hands as they were and allowed the cloth to remain as it is for the next two hours.

P2 person cleaned his hands in the specified manner and after the stipulated time of two hours, removed the cloth immersed in the plastic container on North side having turmeric powder mixed water in it. He spread the cloth for drying on the same place where it was kept earlier, while doing so, he allowed some turmeric powder mixed water dripping from the cloth to fall on the Banyan leaves covered area on the sand bed. The person completed the steps within 5 minutes and the same P2 person completed all those activities in respect of the cloth immersed in the turmeric powder mixed water on the South side.

Step 5: When the cloths are hanging on the strings for drying purpose, the sides touching each other can be called inner-side and external sides can be called outer-side. Both the cloths kept for drying on the coir string above the C North and C South Black Limestone platforms were removed when they were half dried.

The cloths were tied to the thick aerial roots of the Banyan Tree 6 feet above the ground level with the help of plastic string. Either of the P1 & P2 persons did this job after cleaning his hands in the specified manner. The cloth on the North side string was removed gently and spread on the plastic string in reverse position. This meant that the inner-side of the cloth on coir string was now outer-side on plastic string and the cloth was hanging in equal measure on both sides of the string.

Then the cloth was taken to the Banyan Tree and tied to one of its thick aerial roots with plastic cord at a height of 6 feet from the ground level. Immediately the same person did the same process for the cloth on South side.

Both the cloths were kept in this position for 18 hrs. After stipulated 18 hrs the cloths were taken inside the enclosure. While doing this, the cloths were kept above the bioformulation barrel in the same position as they were to the aerial root of the banyan tree.

Step 6: A 2 sq. mm. copper wire was tied at the height of 30 inches above the plastic container in which the bioformulation was being developed. Either of the P1 or P2 persons brought both the cloths tied to the aerial roots of the Banyan Tree by using plastic hand gloves and kept both cloths together on the copper wire string hanging above the plastic container, in which the bioformulation was being developed, while placing the cloth on the copper wire, it was confirmed that the length of the cloth on either side of the string was equal, speed of the pump was doubled so that pipe in the bioformulation will blow the air at the speed of 50 Litters Per minute. This arrangement enables the bioformulation droplets to deposit on both the cloths and after accumulating the drops they would again trickle down back in the bioformulation in the container below.

This process was continued for 72 hours. The daily routine work of watering the sand bed and sprinkling water on the leaves covered area to keep it moist was resumed again.

After 72 hours time, either P1 or P2 person after cleaning his hands in the specified manner, removed the cloths from copper wire string and tied them again to the thick aerial roots of Banyan Tree at the same place. However new coir strings were used this time and cloths were spread in single sheets and not in a folded manner. Side of the cloth initially referred as the outside and becoming the inside on the copper wire string now stuck to the aerial root and the cloths were tied in this position at the same position as tied earlier and for 36 hours.

After the period of 36 hours P1 & P2 person removed both the cloths by using Rubber hand gloves and the coir strings were left then and there. Both the cloths were kept spread on various branches of the cluster fig tree at a height of 8 to 10 feet above the ground level. The outer-side of the cloth while on aerial roots was now gone to inside position. Sprinklers were placed so as to throw drops of water on both the cloths which were kept for drying on cluster fig tree branches. The fountain was kept running for 8 hours. After the fountain was stopped, a period of 36 hours was allowed to pass and 36 hours later the cloths were removed from the place and kept in plastic bag in the specified manner. This enriches the bioformulation.

Step 7: The area having natural soil admeasuring 7×7 feet under the canopy of tree selected earlier in the polluted area was cleared with clean hands. Leaves, fruits, flowers, twigs etc. were removed. Grass was removed. A roof shed of 7×7 feet size was constructed on this cleaned ground at the height of 5 feet above the ground level. Plastic or tin was used for roof structure. 2 Kg. ant-hill soil was spread on the cleared ground. This soil was procured from any ant-hill in the nearby jungle and the place was suitably moistened. The stones obtained from the same polluted area were placed in three layers on this wet ground. For this purpose, naturally smoothened stones of 3″ to 4″ size were assembled together and a 6 inch high mud bank/weir was constructed. Both the cloths were spread on the stones and 75 Liter water was poured on them.

For the next 12 days both the cloths were allowed to soak slowly, every day 3 times with 20 Liter water each time this schedule was maintained for 12 days. In the event of not finding a suitable tree of this type in the polluted surrounding, a two feet thick bed of 7×7 feet size made of soil or sand at any place under the shade of any tree and the plastic pot containing the plant which was used earlier, was placed at the center and naturally smoothened stones from that place were placed in three layers.

An earthen weir, 4 inches in height was constructed around the stone structure and both the cloths were spread on the stones. A total 15 litre pure water was gradually poured on the cloths and then after every day 5 litre water was gently sprinkled on the cloth twice daily for next 12 days.

On the 13th day no water was sprinkled on the cloths and having seen that cloths are dried properly, the cloths were packed in separate paper packets. Before making the packets, 4 stones each which had stuck to the cloth earlier on the upper crust were packed in the plastic bags in specified manner and were brought to the place where the bioformulation is developed.

On bringing the cloth to the place where the bioformulation is being developed taking out the stones with clean hands placed touching the trunk of the Banyan Tree and Cluster fig tree. Four stones were kept at each tree and the cloths were kept on the ground near the trees. The cloth and stones were covered with 6 inch thick mulch of leaves. Antidotes nullifying the toxic matter will form in the Audumbar Kalki Bioculture till the process is completed.

In this embodiment, the turmeric powder used was made by slowly grinding the 100% certified organic turmeric corms on stone grinding wheels. It was stored in airtight plastic container. The Ash is wood ash made from burning only the branches of local indigenous trees (not grass, coconut fronds or coconut leaves, or coconut shell or coconut fibres). The water used in the process of the present invention was taken from natural source or from well. It was ascertained that it was fit for human consumption. Bore water was strictly avoided and natural temperature of water should be between 5 to 30° C. All containers, unless and otherwise stated, used are made up of high-grade plastic (having no metal part). Glass containers are used for some specific steps. Except plastic bags, all other containers were washed twice and cleaned at the place away from the quartz soil at the Banyan Tree by using ash and these were used only after drying them in the shaded area without keeping them upside down. The cloths used in the process are unbleached. The cloth under use was made from organic cotton yarn weaved on handloom. It is thin undyed cotton cloth. Two cloth pieces of 2 feet×5 feet size are required for one cycle. 4 feet×8 feet cloth is required for covering the bioformulation. Some more sundried required lengths of cloth also may need to be used. The cloths are handled with clean washed hands at all stages of the process. Food grade organic Jaggery was sourced in suitable broken form. It was used within 12 months period after the date of manufacture. It was kept in duly sealed plastic bags in 250 gm packages. Once a packet was opened all the jaggery was used.

Clean blank printing papers were used for wrapping cloth etc. Clean undyed organic cotton thread was used wherever cotton thread is mentioned. Clean Plastic thread was used wherever plastic thread is mentioned. Jack fruit stem wood was used for poles and planks used in the preparation. Rubber gloves are used for certain peculiar operations.

The black limestone sandwiches are kept fragrant by incorporating Natural fragrances. The Natural Fragrances, Natural scents or Natural powdered aromatic substance are selected from Nutmeg, Cinnamon, Black Pepper, White pepper, cardamom seeds, Asafoetida, Saffron, Coriander seeds, clove, Dry Ginger, Black Cumin, Cubeb pepper, Black Cardamom, Mace, Dried pomegranate seeds, mustard seeds, fenugreek seeds, fennel, star anise, white sesame, Dried rose petals, lemon grass, Turmeric fingers, Dill weed, Carom seeds, Bay leaf, Tea leaves, Lavender, Peppermint, Citronella, Ylang Ylang, Eucalyptus, Orange Rosemary, Lemon Leaf, Frankincense, Blue berry extract, Apricot oil, Jojoba oil, vetiver, citron, Tangerines, Cayenne pepper, Cumin seeds, Nigella seeds each 60 g which have a natural aromatic fragrances and have a lasting life, to be taken and ground to bring it in powder form separately.

In case grinding is not possible due to their softness, they should be taken between two stones and crushed softly. The stones taken for grinding and crushing purpose were of basalt variety and the powdered material was inserted in the Black Limestone Sandwich with a plastic cup and plastic spoon.

All Black Limestone stones for making the Sandwiches are placed their unpolished side facing each other. Separate Black Limestone sets were used for different natural compounds. Black Limestone used once were discarded and new Black Limestone sets were used instead of the earlier ones.

The natural medicinal fragrant oil components or the powdered natural aromatic material was kept in Black Limestone sandwiches for different periods varying from 35 to 50 days. That material was consigned to the inside of the Black Limestone sandwich on the sand-bed. Then both the Black Limestones were taken under the Banyan Tree and kept on the quartz soil at Banyan Tree, washed with water and covered them there only with green leaves of Banyan Tree.

In another aspect of the invention, the present invention describes a method of preparing working solutions from the stock solution of the bioformulation.

In an embodiment, 100 litres of working solution of the bioformulation is prepared. Any place at room temperature and with fairly good breathable air is selected wherein an open 100 liter plastic container is placed and 10 ml of stock solution of the bioformulation is added followed by sequential addition of jaggery. The jaggary is added in the following manner.
1st day 250 gm
2nd day 750 gm

From the second day onwards, till the day of usage, the working solution was stirred once in a day and used on the 5th/6th/7th day. If it is not to be used till 7th day and to be kept up to three months without usage, it is kept as it is in the container and covered with two layers of cloth. During this time it is not stirred.

Before two days of the day of usage, the working solution was stirred and mixed with 500 gm jaggary and stirred once a day for two days.

If for a particular application, the jaggary usage is less, the solution is diluted by that proportion. For example, the application is for 200 g Jaggary per 100 litre. The solution is added with 4 parts of water. If the needed proportion of jaggary is more, it should be added two days before and used. If all the prepared solution is used up and needs to be used again, it will have to be prepared again.

Alternatively, on the day of usage about 5 litre working solution is left in the container, 95 litre water is added along with appropriate quantity of jaggery in it.

In another embodiment, the stock solution of the bioformulation is hibernated and/or made concentrated in liquid or powder form.

In an embodiment, application of specifically prepared working solution of bioformulation is described. The working solution of bioformulation is used for treating waste water, rivers, water bodies, polluted soil, polluted air, solid wastes, etc. However, the concentration of working solution used for treating may defer based on the application.
1. Application of working solution for wastewater and/or polluted streams or river treatment:
   1. Waste water generated from animal products like milk, excreta of animals or human, slaughter houses, industrial activities, etc. are fed to septic tanks, biogas plants, sewage treatment plants or large tanks. This waste water that remains stagnant in aerobic or anaerobic condition without coming in contact with soil is treated with the working solution. 1200 liters of working solution is added to the inlet of tanks or treatment plants per ML per 15 days. To this solution, 2 Kg/100 liter of jaggery is added.
   2. Waste water generated from any sort of sewage water, industrial activities including organic ingredients released into open or closed gutters, stream, rivers that includes flowing water in contact with soil, need specific steps to be followed for better treatment using working solution. 1000 liters of working solution is added to the inlet of system per ML/Weekly. To this solution, 2 Kg/100 liter of jaggery is added.
   Steps to be followed for effective treatment of waste water, however, these are not mandatory:
      a. When working solution is applied in any natural stream or in the river effective results will be obtained if applied in comparatively cleaner section having rocky bed.
         b. Before applying working solution in natural system or in a river, 3 to 4 inch long cotton thread strand is added to the solution and released to flow. Best proportion is 4 kg cotton strands for every 100 liters of working solution.
         c. On periodic application of working solution, before every 6th application, cow urine from indigenous cows is released in the water stream (10% cow urine of the volume of working solution). The cow urine and working solution are let to flow one by one on rocky area of the river bed.
         d. In case if there are no rocks in the river bed, need to place a few rocks adjacent to the bank of river and release the cow urine by pouring it on these rocks and immediately after this release, the working mixed with the cotton strands is allowed to flow at 5 meters upstream from the location which has rocky river bed placed.
   3. For underground drainage system, 1300 liters of working solution is added per ML/week. To this solution, 2 Kg/100 liter of jaggery is added.
   4. For seepage water/water runoff from the lands or farms contaminated with chemical fertilizers or chemical pesticides or fungicides or herbicides, 200 liters of working solution is added per ML/week. To this solution, 200 gm/100 lit of jaggery is added.
   5. For non-flowing waterbodies created both naturally and by anthropogenic activities that is in contact with the soil at base, stagnant water bodies, reservoirs and where stream/river water flow has been arrested by dam, 200 liters of working solution is added per ML/week. To this solution, 200 gm/100 lit of jaggery is added.
   6. For water that has lost contact with soil such as water stored in water tanks, concrete sided ponds, or even covered tanks, 50 liters of working solution is added per ML/week for treating the water. To this solution, 200 gm/100 lit of jaggery is added.
   7. For wastewater containing chemicals or waste water generated from industrial wastewater or ETP or aquaculture or fishery ponds or water used in nuclear reactors,
      1200 liters of working solution is added per ML/week. To this solution, 1 Kg/100 lit of jaggery is added. Along with working solution, before every sixth dosing, 10% of working solution equivalent of cow urine is to be released separately before the flow.
   8. For wastewater from the ponds that includes aquatic organisms or algae or water from stone quarries, 200 liters of working solution is added per ML/Week. To this solution, 600 gm/100 lit of jaggery is added.
   9. For waste water generated after boiling like in boilers or nuclear reactors and water used in refinery, 250 liters of working solution is added per ML/Week. To this solution, 1 Kg/100 lit of jaggery is added.
   10. For waste water generated in the cage cultures for aquaculture in natural water habitats, in the proportion of the water volume within the cage, 200 liters of working solution is added per ML/Week. To this solution, 600 gm/100 lit of jaggery is added.
   11. For treating bore well or tube well water, 40 liters of working solution is added per bore/fortnight irrespective of the bore well (tube well) size.
2. Application of working solution for biodegradable solid waste (dry waste or wet waste) treatment:
   1. In winter or summer season: 50 liters of working solution is diluted to 200 liters and sprayed on biodegradable waste per ton.
   2. During monsoon season: 50 liters of working solution is diluted to 100 liters and sprayed on biodegradable waste per ton.
3. Application of working solution on work places:
   Places such as vegetable market, fruit market, fish market, slaughter houses, meat market, mushroom cultivation project, sugar mill, slums, hospitals, old age homes, schools, piggeries, poultries, temples, mining areas, laboratories, etc., are sprayed or sprinkled with working solution to keep the environment clean. 5 liters of working solution is diluted to 20 liters with water and sprayed or poured or sprinkled per 100 square meter area. This solution is sprayed every 2 days to 7 days based on the severity of the condition.
4a. Application of working solution in agriculture to enhance plant growth by improving soil quality:
   a. Application of working solution on all plants per acre:
      1. Plants up to the age of 2 years: 200 liters of working solution is mixed with 5 times of water and used for spraying and/or drenching and/or irrigation every 15 days.
      2. Plants 3 to 5 years old: 300 liters of working solution is mixed with 4 times of water and used for spraying and/or drenching and/or irrigation every 15 days.
      3. Plants above 6 years: 400 liters of working solution is mixed with 4 times of water and used for spraying and/or drenching and/or irrigation every 15 days.
4b. Application of working solution in agriculture to enhance plant growth
   a. Application of working solution for seed treatment:
   Method 1:
      1. Soak the seeds or corms in the 8% (diluted) working solution in plastic vessel and keep for 4 hours and dry in shade.
      2. Dry these seeds on plastic or natural stones or soil or soil with cow dung plaster.
      3. Depending on what surface seeds are dried, they are planted in various time durations. Seeds dried on plastic should be used in 24 hours from soaking, seeds dried on the rock should be used in 4 days from soaking, seeds dried on indigenous cow dung plastered soil should be used anytime up to one year.
      4. Airtight bags or containers are used for longer storage.
   Method 2:
      1. 1 Kg seeds are mixed well in 25 ml hibernated working solution.
      2. These seeds are then dried under shade on plastic sheet and either sowed or stored in air tight container.
   b. Application of working solution for vegetative propagation:
      Vegetative parts of plants are soaked in 8% of working solution for 30 minutes and are then planted.
   c. Application of working solution for seedlings/saplings taken out for replanting:
      Roots are soaked in 8% of working solution for 20 minutes and are then planted.
   d. Application of working solution for tissue culture plants:
      Only the roots from the root trays are soaked in 4% dilution of working solution for 20 minutes and are then planted.
5. Application of working solution in polluted air:
   On applying the working solution for removal of pollution from water/solid waste/soil and/or plants, air from such area is also purified. Particulate matter in the air also gets reduced to great extent. Moreover, working solution is designed specifically to treat specific air pollutants, for e.g., fire/forest fire, in the vicinity of coal-based power generation stations, vicinity of the operations/systems that are based on coal/fossil fuel/natural gas/composting gas/landfill gas/biogas plants/wood. The working solution should be diluted in three times water and used for air treatment.
   a. Application of working solution where air is in contact with soil:
      For enclosed space, 30 liters of working solution is sprayed or poured or sprinkled per 100 square meter area/fortnight
      For open space, 40 liters of working solution is sprayed or poured or sprinkled per 100 square meter area/fortnight
   b. Application of working solution where air is not in contact with soil:
      For enclosed space, 40 liters of working solution is sprayed or poured or sprinkled per 100 square meter area/fortnight
      For open space, 60 liters of working solution is sprayed or poured or sprinkled per 100 square meter area/fortnight.
   c. Application of additional working solution in following conditions:
      1. If the human density in the area is more than 1 person per 7 square meter area, 40% more working solution is used.
      2. If there are electrical or electronic equipment, 10% more working solution is used.
      3. If the place is generating hydroelectricity, 30% more working solution is used.
      4. If there is excess electromagnetic force, 15% more working solution is used.
      5. In the area affected with radioactive leakage, 15% more working solution is used.
      6. If the place has anaerobic condition, 10% more working solution is used.
      7. In case if more than one factor as mentioned above is applicable, higher percentage value among them is used.

These and other embodiments will be apparent to those of skill in the art and others in view of the following detailed description of some embodiments. It should be understood, however, that this summary and the detailed description illustrate only some examples of various embodiments and are not intended to be limiting to the invention as claimed. The following examples illustrate the invention but are not limiting thereof.

### Examples

### Example 1: Effect of Working Solution of Bioformulation on Air Quality

### Example 1a: Effect of Working Solution of Bioformulation on Air Quality Monitored in Vengurla, Maharashtra

Effect of working solution on air quality was monitored on the busy public road, busy market square of Vengurla town, Maharashtra (15° 51′46.1″N 73°38′05.4″E). The air quality parameters such as carbon monoxide, sulphur dioxide, particulate matter, along with wind speed and wind direction were studied before and after applying working solution.

The results of air quality parameters are tabulated in below table 1.

TABLE 1
Air Quality Parameters before and after application
of working solution of bioformulation

| | | Value | | | |
|---|---|---|---|---|---|
| | | | 5 minutes | 20 minutes | |
| | | Before | after | after | |
| Date: 29 Dec. 2021 | | application | application | application | |
| Sr. | | of working | of working | of working | |
| no | Parameters | solution | solution | solution | Unit |
| 1 | CO | 4.89 | 0.14 | 0 | ppm |
| 2 | SO₂ | 0.21 | 0 | 0 | ppm |
| 3 | PM1 | 22.33 | 19.29 | 15.66 | μg/m3 |
| 4 | PM2.5 | 33.45 | 24.32 | 19.99 | μg/m3 |
| 5 | PM10 | 50.51 | 24.73 | 23.26 | μg/m3 |
| 6 | Wind Speed | 1 | 1 | 2 | kmph |
| 7 | Wind | 269 | 298.87 | 275.75 | deg |
| | Direction | | | | |

Result: From the observation table 1, it is clear that the particulate matter (PM 1, PM 2.5 and PM 10) was significantly reduced after application of working solution in few minutes. The concentration of carbon monoxide and sulphur dioxide showed significant results that reduced the concentration of pollutants (CO and SO₂) to 0 ppm after application of working solution.

### Example 1b: Effect of Working Solution on Outdoor Air Quality Evaluated at Sewage Treatment Plant (STP) Exhaust

Effect of working solution of bioformulation on outdoor air quality was evaluated at STP Exhaust. The air quality parameters such as sulphur dioxide, nitrogen dioxide, hydrogen sulphide, ammonia, methane and carbon monoxide were studied before and after applying working solution of bioformulation after 15 days.

The results of air quality parameters are tabulated in below table 2.

TABLE 2
Outdoor Air Quality at STP Exhaust before and after
application of working solution of bioformulation

| | | | Before | After | |
|---|---|---|---|---|---|
| | | | application | application | |
| | | | of working | of working | |
| Sr. | | | solution | solution | % |
| No. | Parameter | Unit | (21 Mar. 2022) | (4 Apr. 2022) | Difference |
| 1 | Sulphur Dioxide | μg/m3 | 48.97 | 12.4 | −75% |
| | (SO₂) | | | | |
| 2 | Nitrogen Dioxide | μg/m3 | 25.18 | 15.4 | −39% |
| | (NOx) | | | | |
| 3 | Hydrogen Sulphide | μg/m3 | 8.41 | 3.28 | −61% |
| | (H₂S) | | | | |
| 4 | Ammonia (NH₃) | μg/m3 | 23.13 | 11.81 | −49% |
| 5 | Methane (CH₄) | μg/m3 | 2.09 | 1.02 | −51% |
| 6 | Carbon Monoxide | μg/m3 | 0.32 | 0.11 | −65% |
| | (CO) | | | | |

Result: From the observation table 2, it is observed that the pollutants sulphur dioxide, nitrogen dioxide, hydrogen sulphide, ammonia, methane and carbon monoxide were significantly reduced after 15 days of applying working solution.

### Example 1c: Effect of Working Solution of Bioformulation on Indoor Air Quality in Gents Washroom/Toilet Blocks

Effect of working solution on indoor air quality was assessed in washroom/toilet blocks. The air quality parameters such as sulphur dioxide, nitrogen dioxide, hydrogen sulphide, ammonia, methane and carbon monoxide were studied before and after applying Working solution after 15 days. The results of air quality parameters are tabulated in below table 3.

TABLE 3
Outdoor Air Quality in Washroom/toilet blocks before and
after application of working solution of bioformulation

| | | | Before | After | |
|---|---|---|---|---|---|
| | | | application | application | |
| | | | of working | of working | |
| Sr. | | | solution | solution | % |
| No. | Parameter | Unit | (21 Mar. 2022) | (4 Apr. 2022) | Difference |
| 1 | Sulphur Dioxide | μg/m3 | 71.02 | 11 | −84% |
| | (SO₂) | | | | |
| 2 | Nitrogen Dioxide | μg/m3 | 48.18 | 24.94 | −48% |
| | (NOx) | | | | |
| 3 | Hydrogen Sulphide | μg/m3 | 7.72 | 1.98 | −74% |
| | (H₂S) | | | | |
| 4 | Ammonia (NH₃) | μg/m3 | 33.18 | 7.97 | −75% |
| 5 | Methane (CH₄) | μg/m3 | 1.11 | 0.82 | −26% |
| 6 | Carbon Monoxide | μg/m3 | 0.18 | 0.13 | −27% |
| | (CO) | | | | |

Result: From the observation table 3, it is observed that the air pollutants sulphur dioxide, nitrogen dioxide, hydrogen sulphide, ammonia, methane and carbon monoxide were significantly reduced after 15 days of applying working solution in 5 the washroom/toilet blocks.

### Example 2: Effect of Working Solution of Bioformulation on Air, Water and Sludge Analysis of Ram Nadi River

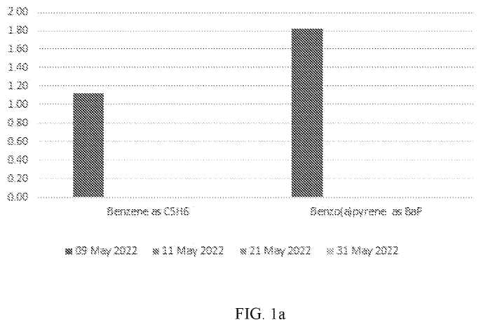

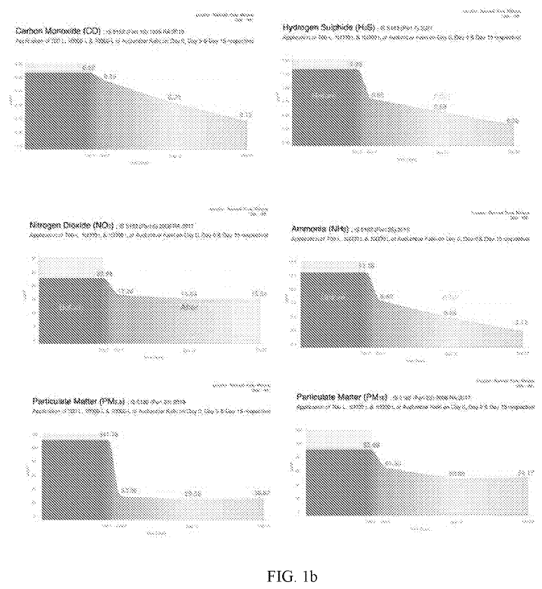

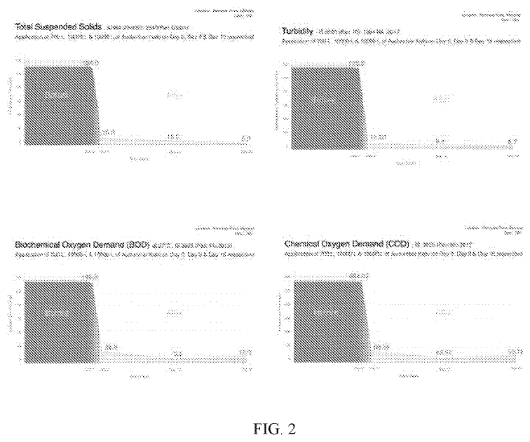

Ram Nadi river was chosen for the pilot study as it has short length rivulet with accessible banks, stable flow, presence of sewage especially in the month of summer, it carries sewage mixed with water discharged from vehicle washing stations and the flow in this stretch is about 1.6 MLD at dosing point and 2.5 to 3.0 MLD at sampling point. Working solution was added in three doses (700, 2000 and 8000 litres) on 9 May, 18 May and 24 May 2022 at the sites.
1. Ambient Air Analysis: The air quality parameters such as benzene, benzopyrene, nitrogen dioxide, hydrogen sulphide, ammonia, carbon monoxide, particulate matter (PM2.5 and PM10) were studied before and after applying working solution.
   Result: The levels of Benzene and Benzopyrene were immediately reduced below detectable limit (BDL) after the first dosing itself and sustained BDL through the three testing over 3 weeks (FIG. 1a). The levels of nitrogen dioxide, hydrogen sulphide, ammonia, carbon monoxide, particulate matter (PM2.5 and PM10) as displayed in FIG. 1b were significantly reduced after application of three doses of working solution.
2. Water Analysis: The water quality parameters such as total suspended solids, turbidity, BOD and COD were studied before and after applying working solution.
   Result: The amount of total suspended solids and turbidity (FIG. 2) was significantly reduced after application of three doses of working solution in the Ram Nadi River. Also, BOD and COD levels that indicate the organic matter in water were significantly reduced from 140 and 560 to 15 and 62 mg/lit respectively as shown in FIG. 2 in 20 days (11th May to 31st May).
3. Organic Matter and Sludge Analysis: Parameters such as organic matter reduction in water, water depth and sludge thickness were studied before and after application of working solution within a span of 20 days. Further, colour, odour, appearance, specific gravity, density, settle ability and organic matter were studied after application of working solution.
   Result: The sludge thickness was significantly reduced by 200 mm from 900 mm (before application of working solution) to 700 mm (after application of working solution) in 20 days whereas water depth was significantly increased from 1300 mm to 1600 mm after applying working solution in 20 days. Increase in water depth was attributed to decrease in sludge depth that further led to softening of the sludge.
      A total of 420,900 kg Organic matter (contributed by reduction in sludge-396,000 kg and COD-24,900 kg) was reduced and treated in a span of 20 days. 396,000 kg of sludge was liquified in just 3 weeks (20 days).
      The parameters such as colour, odour, appearance, specific gravity, density, settle ability and organic matter of sludge are displayed in below table 4. The specific gravity and density of the sludge was significantly reduced by 30% and 23% respectively in 20 days. However, organic matter was increased significantly by 13% in 20 days.

TABLE 4
Sludge analysis after application of
working solution of bioformulation

| | | | After | After | |
|---|---|---|---|---|---|
| | | | application | application | |
| | | | of working | of working | |
| | | | solution | solution | |
| Sr. | | | (11 May | (31 May | |
| No. | Parameters | Unit | 2022) | 2022) | Remark |
| 1 | Colour | — | Black Colour | Black Colour | |
| 2 | Odour | — | Disagreeable | Disagreeable | |
| 3 | Appearance | — | Blackish | Blackish | |
| | | | semi solid | semi solid | |
| | | | sludge | sludge | |
| 4 | Specific | — | 2.10 | 1.48 | 30% lighter |
| | Gravity | | | | material |
| 5 | Density | g/cc | 1.83 | 1.42 | 23% less |
| | | | | | dense |
| 6 | Settle- | — | Present | Present | |
| | Ability | | | | |
| 7 | Organic | % | 1.60 | 1.81 | 13% richer in |
| | Matter | | | | organic matter |

4. Microbiological Analysis of Sludge: Microscopic observation of the sludge was carried out to study the morphology of bacteria, total plate count and presence aerobic and anaerobic bacteria after application of working solution after 20 days.
   Result: The results of microscopic observation of the sludge for morphology of bacteria, total plate count and presence aerobic and anaerobic bacteria are displayed in below table 5. Motile gram-positive short cocci and 30% increase in aerobic count and total plate count was observed. Also, presence of anaerobic bacteria was observed. Presence of aerobic and anaerobic bacteria in the sludge is considered beneficial for 10 treatment of sludge.

TABLE 5
Microbiological analysis before and after application
of working solution of bioformulation

| | | | After | After | |
|---|---|---|---|---|---|
| | | | application | application | |
| | | | of working | of working | |
| | Micro- | | solution | solution | |
| Sr. | biological | | (11 May | (31 May | |
| No. | Parameters | | 2022) | 2022) | Remark |
| 1 | Microscopic | — | Motile Gram- | Motile Gram- | |
| | Bacterial | | Positive short | Positive short | |
| | Examination | | rods | Cocci | |
| 2 | Total plate | cfu/g | 4.5 × 10⁶ | 5.9 × 10⁶ | 30% |
| | count | | | | increase in |
| | | | | | biomass |
| 3 | Aerobic | cfu/g | 4.0 × 10⁶ | 5.3 × 10⁶ | 30% |
| | Count | | | | increase in |
| | | | | | biomass |
| 4 | Anaerobic | per g | Present | Present | |
| | Counts | | | | |

### Example 2: Effect of Working Solution of Bioformulation on Soil Analysis of River

Effect of working solution of bioformulation was assessed on soil collected from Ram Nadi River. Soil analysis parameters such as pH, nitrogen, phosphorus, potassium, magnesium, calcium, zinc and manganese were studied before and after applying working solution in 10 days.

The results of Soil analysis are tabulated in below table 6.

TABLE 6
Soil analysis before and after application
of working solution of bioformulation

| | | After | After | |
|---|---|---|---|---|
| | Before | application | application | |
| | application | of working | of working | |
| River | of working | solution | solution | |
| Soil | solution | (700 L) | (10,000 L) | |
| Test | 9 May 2022 | 11 May 2022 | 21 May 2022 | Remark |
| pH | 8.83 | 8.42 | 8.26 | Progress |
| | | | | towards |
| | | | | Neutral pH |
| Nitrogen | 425.32 | 481.06 | 415.2 | |
| (mg/Kg) | | | | |
| Phosphorus | 1.50 | 1.60 | 423.15 | 282 times |
| (mg/Kg) | | | | rise |
| Potassium | 72.1 | 74.13 | 653.24 | 9 times rise |
| (mg/Kg) | | | | |
| Calcium | 124.33 | 87.39 | 39236.11 | 316 times |
| (mg/Kg) | | | | rise |
| Magnesium | 100.71 | 50.52 | 3877.31 | 38 times rise |
| (mg/Kg) | | | | |
| Zinc | BDL | BDL | 47.69 | Remarkable |
| (mg/Kg) | | | | increase |
| Manganese | BDL | BDL | 368.06 | Remarkable |
| (mg/Kg) | | | | increase |

BDL—Below Detectable Level

Result: From the observation table 6, it was observed that the pH of soil was decreased from 8.83 to 8.26 in 10 days after application of working solution. Also, the nutrients (P, K, Ca and Mg) were significantly enhanced in 10 days after application of working solution. There was remarkable increase in the Zn and Mn content of the soil that was below detectable level (BDL) before application of working solution in 10 days.

### Example 3: Effect of Working Solution of Bioformulation on Water Quality Analysis

Water quality was monitored at a Sewage Treatment Plant water was evaluated pre and post application of working solution. Effect of Working solution on outdoor air quality was evaluated at an STP Exhaust. The water quality parameters such as pH, total dissolved solids, total hardness, sulphates, alkalinity, chlorides, total bacterial count, coliform, E. coli, odour, turbidity, calcium, magnesium, BOD and COD were studied before and after applying working solution.

The results of air quality parameters are tabulated in below table 7.

TABLE 7
Water Quality Analysis in Sewage Treatment Plant before and
after application of working solution of bioformulation

| | | | | After | |
|---|---|---|---|---|---|
| | | | Before | application | |
| | Name of | | application | of working | |
| Sr. | Parameter | | of working | solution | |
| No. | checked | Unit | solution | (1^{st} Dose) | Remark |
| 1 | PH | N.S. | 7.9 | 8 | |
| 2 | Total | mg/l | 805 | 865 | |
| | Dissolved | | | | |
| | Solid | | | | |
| 3 | Total Hardness | mg/l | 492 | 527 | |
| 4 | Sulphates | mg/l | 170 | 141 | |
| 5 | Alkalinity | mg/l | 315 | 384 | |
| 6 | Chlorides | mg/l | 210 | 210 | |
| 7 | Total Bacterial | cfu/ml | >300 | >300 | |
| | Count | | | | |
| 8 | Coliform | MPN/ | 2 | 2 | |
| | | 100 ml | | | |
| 9 | E. coli | Per/ | Absent | Absent | |
| | | 100 ml | | | |
| 10 | Odour | N.S | Agreeable | Agreeable | |
| 11 | Turbidity | NTU | 1.4 | 1.2 | |
| 12 | Calcium | mg/l | 103 | 109 | |
| 13 | Magnesium | mg/l | 55 | 59 | |
| 14 | Chemical | mg/l | 35.86 | 19.92 | 44% |
| | Oxygen | | | | reduction |
| | Demand | | | | |
| | (COD) | | | | |
| 15 | Biological | mg/l | 12 | 6 | 50% |
| | Oxygen | | | | reduction |
| | Demand | | | | |
| | (BOD) | | | | |

Result: From the table 7, it was observed that there was significant reduction in COD and BOD values of the water after treatment with working solution. The greater the COD value indicates rapid depletion of oxygen in the stream as oxygen is required to break down pollutants (organic substances) in water whereas greater BOD value indicates rapid depletion of oxygen in the stream so that less oxygen is available to higher forms of aquatic life. Decrease in COD value indicated reduction of pollutants in water after applying 1st dose of working solution.

### Example 4: Effect of Working Solution of Bioformulation on Nutrient Analysis of Garden Soil

Effect of working solution on nutrient analysis of garden soil was assessed. The parameters such as pH, Nitrogen, Phosphorus, Potassium, Calcium, Magnesium, Zinc and Manganese were studied before and after applying Working solution after 15 days.

The results of nutrient analysis of soil are tabulated in below table 8.

TABLE 8
Nutrient analysis of Garden soil before and after
application of working solution of bioformulation

| | | | Before | After | |
|---|---|---|---|---|---|
| | | | Working | Working | |
| Sr. | | | (21 Mar. | (14 Apr. | % |
| No. | Parameter | Unit | 2022) | 2022) | Difference |
| 1 | pH | — | 8.44 | 7.93 | Towards |
| | | | | | neutral |
| 2 | Nitrogen | mg/kg | 0.77 | 3708.82 | 481600% |
| 3 | Phosphorous | mg/kg | 260.61 | 1056.79 | 405% |
| 4 | Potassium | mg/kg | 1086.38 | 2074.79 | 190% |
| 5 | Calcium | mg/kg | 13499.01 | 20815.33 | 154% |
| 6 | Magnesium | mg/kg | 3100.69 | 5278.39 | 170% |
| 7 | Zinc | mg/kg | 74.53 | 110.34 | 135% |
| 8 | Manganese | mg/kg | 915.16 | 1020.78 | 111% |

Result: From the observation table 8, it was observed that the alkaline pH of soil was decreased by 0.51 units i.e. from 8.44 to 7.93 in 15 days after application of working solution. Also, the nutrients (N, P, K, Ca, Mg, Zn and Mn) were significantly enhanced in 15 days after application of working solution. There was tremendous increase in the nitrogen content of the garden soil after application of working solution.

### Example 5: Effect of Working Solution of Bioformulation on Mosquitoes and Larvae

Effect of working solution of bioformulation was evaluated on mosquitoes and their larvae. The experiment was carried out near Ryan International School that had plenty of mosquitoes in the area. On application of third dose of working solution, the density of mosquitoes was found to be reduced. Also, on assessing the water in the vicinity less larval load was observed.

Similar experiment was carried out at Sharmad Residency, Sheela Vihar Colony, Karve Road, Pune where load of mosquitoes was high in the parking area due to storm drains and sewage overflow. The load of mosquitoes after application of working solution was reduced and remained constant for one month. Later, working solution was reapplied and it was observed that after 3 repeated doses, the mosquito density remained so low that further dosing was not needed.

The process of the present invention yields a bioformulation. The process is sustainable and ecofriendly. The process utilizes raw materials that are easily available. The bioformulation of the present invention is useful for bioremediation. The application of the bioformulation of the present invention has shown improved quality of air, water and soil together by converting the pollutants into highly beneficial nature building products and components like compositions and/or molecules and thereby achieving speedy altogether in situ purification of Air, Water, Soil and Plants. The pollutants are converted into bioabsorbable soil nutrients.

The embodiments were chosen and described in order to best explain the principles of the present invention and its practical application, to thereby enable others, skilled in the art to best utilize the present invention and various embodiments with various modifications as are suited to the particular use contemplated.

It is understood that various omission and substitutions of equivalents are contemplated as circumstance may suggest or render expedient, but such are intended to cover the application or implementation without departing from the scope of the present invention.

1) A process of preparing a bioformulation comprising
a) a first stage of preparing air conditions having least contamination for the making of the bioformulation;
b) a second stage of preparing the bioformulation in the enclosure while maintaining air conditions having least contamination; and
c) a third stage of initiating enrichment of the bioformulation using cloths.

2) The process of preparing a bioformulation as claimed in claim 1, wherein the first stage of preparing air conditions having least contamination for the making of the bioformulation further including
a) a first step of cleaning the hands by the personnel;
b) a second step of preparing the site in vicinity of selected trees; and
c) a third step of preparing the enclosure wherein the bioformulation being prepared.

3) The process of preparing a bioformulation as claimed in claim 2, wherein the first step of cleaning the hands by the personnel including the person being involved in the preparation of the bioformulation to clean their hands up to the elbow by washing twice with ash and clean water followed by air drying the hands.

4) The process of preparing a bioformulation as claimed in claim 2, wherein the second step of preparing the site in vicinity of selected trees including
a) selecting the trees from cluster fig and banyan;
b) removing the unwanted plants and seedlings;
c) allowing leaves, fruits and branches falling from the two selected trees to fall on the ground and remaining there till decay;
d) regularly keeping the soil below the trees wet with water;
e) spreading 40 kg fine powdered quartz (passed through <300 micron mesh) mixed with 8 kg organic turmeric powder in a 10 feet diameter around the cluster fig tree, and spreading 100 kg fine powdered quartz (passed through <300 micron mesh) without any turmeric powder in a 30 feet diameter around the banyan tree; and
f) placing under these trees, on the quartz powder, in two layers, naturally smoothened stones, brought from polluted areas, such that the polluted areas being selected from polluted ecosystems or area, fields, farms, gardens where insecticides and pesticides being used, polluted water streams, rivers, sources, urban and human affected places, pens for birds and animals.

5) The process of preparing a bioformulation as claimed in claim 2, wherein the third step of preparing the enclosure for preparation of bioformulation including constructing the enclosure in the vicinity of the selected trees such that the enclosed built environment being conducive for easy air ventilation; the enclosure being at 900 of both the trees and 40 feet away from the cluster fig tree in south direction and 40-50 feet away from the Banyan Tree in East direction; the enclosure measuring 65 feet in North South direction and 45 feet in East West direction.

6) The process of preparing a bioformulation as claimed in claim 1, wherein the second stage of preparing the bioformulation in the enclosure while maintaining air conditions having least contamination including
a) a first step of placing an open plastic barrel of 200 litre capacity on two Black Limestones called ‘P platform’ and adding 180 litre water to the barrel followed by addition of jaggery, such that the proportion of jaggery being 1 kg per 100 Litre of water, and keeping the mixture undisturbed without stirring on the day 1 after adding jaggery;
b) a second step of adding more jaggery on Day 2 followed by introducing a wooden plank obtained from jackfruit tree being allowed to remain there in the barrel such that the size of the wooden plank being smoothened with a carpenter plane to 4 inch wide one inch thick and 5 feet long, and few scratches being made with iron nail on all four sides of the smoothened plank, and the plank being changed every month, and the old plank being left under the banyan or Cluster fig tree touching its trunk;
c) a third step of aerating the mixture in the barrel by an external air pump ensuring proper air-circulation in the mixture for preparing the bioformulation, such that a stone procured from natural habitat having no human interference being tied to the pipe end with cotton thread and the pipe being lowered inside, the pipe so dipped being changed every month and the old one being left under the Cluster fig or Banyan tree touching its trunk; and
d) a fourth step of covering the container for making the bioformulation with double layered cloth such that the cloth piece being 4 feet×8 feet size, the cloth being immersed for 8 hours in water in a glass vessel being kept near the 2 feet×3 feet Black Limestone outside the circumference of quartz soil at Banyan tree, the cloth being taken out and dried on the plastic string in shaded area without squeezing or wringing, removing the cloth with clean hands and keeping on the said Black Limestone and spreading 50 gm ash on it, keeping the ash on the cloth for 2 hrs., picking the cloth along with the ash and keeping in another glass vessel without meddling with it, pouring cold water on cloth to such an extent that a cloth being sufficiently drenched but only partially immersed in the water in the glass vessel, keeping for 4 hrs, shaking the cloth after stipulated 4 hrs only once in the pot itself and pouring 1 litre water on the cloth holding it above the glass vessel, taking the cloth immediately for spreading on another string without squeezing or wrinkling in the shaded area, pouring remaining water in the vessel 36 hrs. after removal of cloth under the Banyan tree inside the circumference of quartz soil at Banyan tree, double layering the cloth and putting on the barrel wherein the bioformulation being developed, the barrel being covered with cloth in a such a way that the portion of the wood plank obtained from jackfruit tree remains out of the barrel not getting covered by the cloth, tying by the coir rope after covering the barrel with double layered cloth, and arranging a plastic string for keeping the cloth as and when it being removed from the barrel.

7) The process of preparing a bioformulation as claimed in claim 1, wherein the third stage of initiating enrichment of the bioformulation using cloths including
a) a first step of preparing the cloth at the enclosure;
b) a second step of preparing the cloth at the polluted site;
c) a third step of treating the cloth at the polluted site;
d) a fourth step of treating the cloths at the enclosure;
e) a fifth step of contacting the cloths with banyan tree;
f) a sixth step of contacting the cloths with the bioformulation; and
g) a seventh step of taking the cloths to the polluted site.

8) The process of preparing a bioformulation as claimed in claim 1, wherein the process further includes preparing a working solution from the bioformulation by sequential addition of jaggery to 10 ml of stock solution to prepare 100 litres of working solution.

9) The process as claimed in claim 8 wherein working solution of the bioformulation is used for wastewater treatment.

10) The process as claimed in claim 8 wherein working solution of the bioformulation is used for solid waste treatment.

11) The process as claimed in claim 8 wherein working solution of the bioformulation is used for treating polluted soil.

12) The process as claimed in claim 8 wherein working solution of the bioformulation is used to enhance plant growth and seed treatment.

13) The process as claimed in claim 8 wherein working solution of the bioformulation is used for vegetative propagation.

14) The process as claimed in claim 8 wherein working solution of the bioformulation is used for treating polluted air.

15) The process as claimed in claim 8 wherein working solution of the bioformulation is used for treating polluted rivers, streams, ponds, lakes and wells wherein water is in contact with soil.

16) The process as claimed in claim 8 wherein working solution of the bioformulation is used for mosquito control wherein the mosquitoes are in adult or larvae form.

17) The process as claimed in claim 8 wherein working solution of the bioformulation is used for converting pollutants into bioabsorbable soil nutrients.
